(19) United States
(12) Patent Application Publication
(10) Pub. No.: US 2025/0371436 A1
(43) Pub. Date: Dec. 4, 2025

(54) METHOD AND SYSTEM FOR PROVIDING LOCAL AND GLOBAL RECOURSE WITH COUNTERFACTUAL RULES

(71) Applicant: JPMorgan Chase Bank, N.A., New York, NY (US)

(72) Inventors: Tom BEWLEY, London (GB); Salim I. AMOUKOU, London (GB); Saumitra MISHRA, London (GB); Freddy LECUE, Mamaroneck, NY (US); Daniele MAGAZZENI, London (GB); Manuela VELOSO, New York, NY (US)

(73) Assignee: JPMorgan Chase Bank, N.A., New York, NY (US)

(21) Appl. No.: 18/677,475

(22) Filed: May 29, 2024

(51) Int. Cl. G06N 20/20

(52) U.S. Cl. CPC G06N 20/20

(57) ABSTRACT

A method for computing regional counterfactual rules to summarize recourse options is disclosed. The method includes receiving model data via an input, the model data including information that relates to a target model and a corresponding data set; training a surrogate model for the target model based on the model data; identifying, by using the surrogate model, rules for an output of the target model based on a predetermined threshold, the rules including a counterfactual rule; enumerating, by using the surrogate model, boundaries for the identified rules to partition an input space into a grid with cells, each of the cells including a hyperrectangular cell; labeling, by using the surrogate model, each of the cells with one of the identified rules based on predetermined optimality criteria; and merging, by using the surrogate model, each of the labeled cells based on a matching of the rules to generate regions of optimality.

### BACKGROUND

### 1. Field of the Disclosure

This technology generally relates to methods and systems for computing counterfactual rules, and more particularly to methods and systems for providing a model-agnostic process for counterfactual explanation that utilizes identified regions of optimality to summarize recourse options as generalized rules.

### 2. Background Information

Many business entities operate vast networks of various machine learning models to facilitate operations as well as to provide services for users. Often, identifying counterfactual explanations such as, for example, counterfactual rules that summarize recourse options provide valuable insight into the various machine learning models. Historically, implementations of conventional counterfactual explanation management techniques have resulted in varying degrees of success with respect to providing local and global recourse with counterfactual rules.

One drawback of using the conventional counterfactual explanation management techniques is that in many instances, established regional counterfactual rules are not robust. As a result, small perturbations may drastically impact the regional counterfactual rules. Additionally, conventional counterfactual rule mining algorithms are prohibitively slow for large feature spaces and data sets.

Therefore, there is a need for a model-agnostic process for local and global counterfactual explanation that utilizes identified regions of optimality to summarize recourse options as generalized rules for both individuals and groups.

### SUMMARY

The present disclosure, through one or more of its various aspects, embodiments, and/or specific features or sub-components, provides, inter alia, various systems, servers, devices, methods, media, programs, and platforms for providing a model-agnostic process for counterfactual explanation that utilizes identified regions of optimality to summarize recourse options as generalized rules.

According to an aspect of the present disclosure, a method for computing regional counterfactual rules to summarize recourse options is disclosed. The method is implemented by at least one processor. The method may include receiving model data via at least one input, the model data may include information that relates to a target model and a corresponding data set; training a surrogate model for the target model based on the model data; identifying, by using the surrogate model, at least one rule for an output of the target model based on a predetermined threshold, each of the at least one rule may include a counterfactual rule; enumerating, by using the surrogate model, at least one boundary for each of the identified at least one rule to partition an input space into a grid with at least one cell, each of the at least one cell may include a hyperrectangular cell; labeling, by using the surrogate model, each of the at least one cell with one of the identified at least one rule based on predetermined optimality criteria; and merging, by using the surrogate model, each of the labeled at least one cell based on a matching of the at least one rule to generate at least one region of optimality.

In accordance with an exemplary embodiment, the method may further include generating, by using the surrogate model, at least one regional rule that summarizes a plurality of recourse options based on the generated at least one region of optimality, wherein the at least one regional rule may be assembled into a global textual summary of the plurality of recourse options; and wherein the global textual summary may include at least one conditional statement.

In accordance with an exemplary embodiment, each of the at least one surrogate model may correspond to a tree-based machine learning model that includes a plurality of nodes, the plurality of nodes may include at least one end node that represents a hyperrectangular rule.

In accordance with an exemplary embodiment, to identify the at least one rule, the method may further include determining, by using the surrogate model, at least one end node based on the model data, wherein each of the at least one end node may correspond to a mapping of the counterfactual rule in the input space; and merging, by using the surrogate model, each the at least one end node based on a matching of at least one characteristic.

In accordance with an exemplary embodiment, the predetermined threshold may include a threshold value that defines a minimum probability of a different model output for the output of the target model, the threshold value may include a percentage value.

In accordance with an exemplary embodiment, the predetermined optimality criteria may include a sparsity criterion that requires a minimal change in a feature value of the target model to alter a predictive outcome.

In accordance with an exemplary embodiment, the predetermined optimality criteria may include a feasibility criterion that requires selection of one of the identified at least one rule according to a proportion of data points within the identified at least one rule when more than one of the identified at least one rule satisfy the sparsity criterion.

In accordance with an exemplary embodiment, the method may further include receiving at least one request to generate a local counterfactual explanation for a single instance of the output; searching each of the generated at least one region of optimality for the single instance of the output, wherein the generated at least one region of optimality that corresponds to the single instance of the output may include a precalculated and optimized counterfactual rule; and generating a report in response to each of the at least one request, the report may include the precalculated and optimized counterfactual rule for the single instance of the output.

In accordance with an exemplary embodiment, the target model may include at least one from among a deep learning model, a neural network model, a machine learning model, a mathematical model, and a process model.

According to an aspect of the present disclosure, a computing device configured to implement an execution of a method for computing regional counterfactual rules to summarize recourse options is disclosed. The computing device including a processor; a memory; and a communication interface coupled to each of the processor and the memory, wherein the processor may be configured to receive model data via at least one input, the model data may include information that relates to a target model and a corresponding data set; train a surrogate model for the target model based on the model data; identify, by using the surrogate model, at least one rule for an output of the target model based on a predetermined threshold, each of the at least one rule may include a counterfactual rule; enumerate, by using the surrogate model, at least one boundary for each of the identified at least one rule to partition an input space into a grid with at least one cell, each of the at least one cell may include a hyperrectangular cell; label, by using the surrogate model, each of the at least one cell with one of the identified at least one rule based on predetermined optimality criteria; and merge, by using the surrogate model, each of the labeled at least one cell based on a matching of the at least one rule to generate at least one region of optimality.

In accordance with an exemplary embodiment, the processor may be further configured to generate, by using the surrogate model, at least one regional rule that summarizes a plurality of recourse options based on the generated at least one region of optimality, wherein the at least one regional rule may be assembled into a global textual summary of the plurality of recourse options; and wherein the global textual summary may include at least one conditional statement.

In accordance with an exemplary embodiment, each of the at least one surrogate model may correspond to a tree-based machine learning model that includes a plurality of nodes, the plurality of nodes may include at least one end node that represents a hyperrectangular rule.

In accordance with an exemplary embodiment, to identify the at least one rule, the processor may be further configured to determine, by using the surrogate model, at least one end node based on the model data, wherein each of the at least one end node may correspond to a mapping of the counterfactual rule in the input space; and merge, by using the surrogate model, each the at least one end node based on a matching of at least one characteristic.

In accordance with an exemplary embodiment, the predetermined threshold may include a threshold value that defines a minimum probability of a different model output for the output of the target model, the threshold value may include a percentage value.

In accordance with an exemplary embodiment, the predetermined optimality criteria may include a sparsity criterion that requires a minimal change in a feature value of the target model to alter a predictive outcome.

In accordance with an exemplary embodiment, the predetermined optimality criteria may include a feasibility criterion that requires selection of one of the identified at least one rule according to a proportion of data points within the identified at least one rule when more than one of the identified at least one rule satisfy the sparsity criterion.

In accordance with an exemplary embodiment, the processor may be further configured to receive at least one request to generate a local counterfactual explanation for a single instance of the output; search each of the generated at least one region of optimality for the single instance of the output, wherein the generated at least one region of optimality that corresponds to the single instance of the output may include a precalculated and optimized counterfactual rule; and generate a report in response to each of the at least one request, the report may include the precalculated and optimized counterfactual rule for the single instance of the output.

In accordance with an exemplary embodiment, the target model may include at least one from among a deep learning model, a neural network model, a machine learning model, a mathematical model, and a process model.

According to an aspect of the present disclosure, a non-transitory computer readable storage medium storing instructions for computing regional counterfactual rules to summarize recourse options is disclosed. The storage medium including executable code which, when executed by a processor, may cause the processor to receive model data via at least one input, the model data may include information that relates to a target model and a corresponding data set; train a surrogate model for the target model based on the model data; identify, by using the surrogate model, at least one rule for an output of the target model based on a predetermined threshold, each of the at least one rule may include a counterfactual rule; enumerate, by using the surrogate model, at least one boundary for each of the identified at least one rule to partition an input space into a grid with at least one cell, each of the at least one cell may include a hyperrectangular cell; label, by using the surrogate model, each of the at least one cell with one of the identified at least one rule based on predetermined optimality criteria; and merge, by using the surrogate model, each of the labeled at least one cell based on a matching of the at least one rule to generate at least one region of optimality.

In accordance with an exemplary embodiment, when executed by the processor, the executable code may further cause the processor to generate, by using the surrogate model, at least one regional rule that summarizes a plurality of recourse options based on the generated at least one region of optimality, wherein the at least one regional rule may be assembled into a global textual summary of the plurality of recourse options; and wherein the global textual summary may include at least one conditional statement.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing a model-agnostic process for counterfactual explanation that utilizes identified regions of optimality to summarize recourse options as generalized rules.

FIG. 4 is a flowchart of an exemplary process for implementing a method for providing a model-agnostic process for counterfactual explanation that utilizes identified regions of optimality to summarize recourse options as generalized rules.

FIG. 5 is a graphical representation of an exemplary process for implementing a method for providing a model-agnostic process for counterfactual explanation that utilizes identified regions of optimality to summarize recourse options as generalized rules.

FIG. 6 is a graphical sequence of an exemplary process for implementing a method for providing a model-agnostic process for counterfactual explanation that utilizes identified regions of optimality to summarize recourse options as generalized rules.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

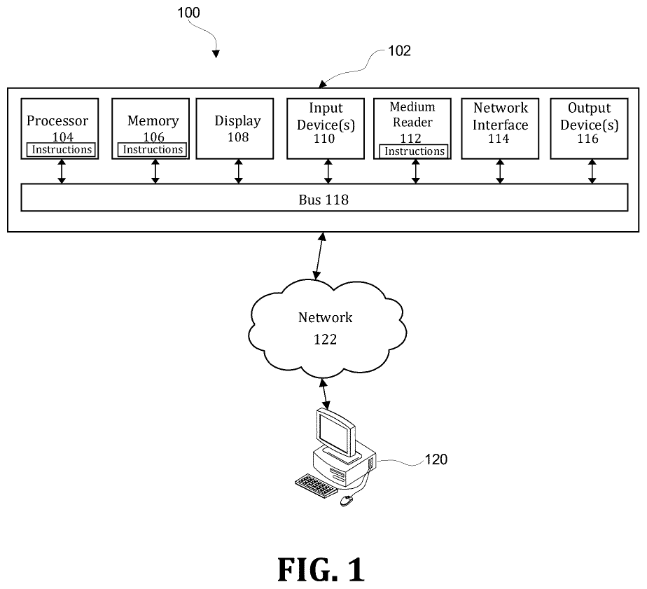

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons skilled in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing a model-agnostic process for counterfactual explanation that utilizes identified regions of optimality to summarize recourse options as generalized rules.

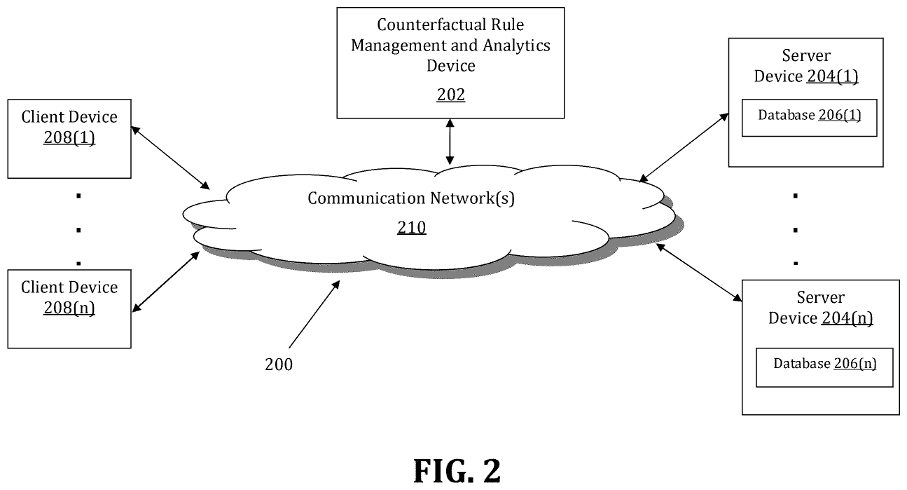

Referring to FIG. 2, a schematic of an exemplary network environment 200 for implementing a method for providing a model-agnostic process for counterfactual explanation that utilizes identified regions of optimality to summarize recourse options as generalized rules is illustrated. In an exemplary embodiment, the method is executable on any networked computer platform, such as, for example, a personal computer (PC).

The method for providing a model-agnostic process for counterfactual explanation that utilizes identified regions of optimality to summarize recourse options as generalized rules may be implemented by a Counterfactual Rule Management and Analytics (CRMA) device 202. The CRMA device 202 may be the same or similar to the computer system 102 as described with respect to FIG. 1. The CRMA device 202 may store one or more applications that can include executable instructions that, when executed by the CRMA device 202, cause the CRMA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CRMA device 202 itself, may be located in virtual server(s) running in a cloud-based computing environment rather than being tied to one or more specific physical network computing devices. Also, the application(s) may be running in one or more virtual machines (VMs) executing on the CRMA device 202. Additionally, in one or more embodiments of this technology, virtual machine(s) running on the CRMA device 202 may be managed or supervised by a hypervisor.

In the network environment 200 of FIG. 2, the CRMA device 202 is coupled to a plurality of server devices 204(1)-204(n) that hosts a plurality of databases 206(1)-206(n), and also to a plurality of client devices 208(1)-208(n) via communication network(s) 210. A communication interface of the CRMA device 202, such as the network interface 114 of the computer system 102 of FIG. 1, operatively couples and communicates between the CRMA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CRMA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CRMA devices that efficiently implement a method for providing a model-agnostic process for counterfactual explanation that utilizes identified regions of optimality to summarize recourse options as generalized rules.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CRMA device 202 may be a standalone device or integrated with one or more other devices or apparatuses, such as one or more of the server devices 204(1)-204(n), for example. In one particular example, the CRMA device 202 may include or be hosted by one of the server devices 204(1)-204(n), and other arrangements are also possible. Moreover, one or more of the devices of the CRMA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CRMA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to model data, target models, data sets, surrogate models, counterfactual rules, model outputs, predetermined thresholds, hyperrectangular cells, predetermined optimality criteria, and regions of optimality in an input space.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CRMA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CRMA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CRMA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CRMA device 202, the server devices 204(1)-204(n), or the client devices 208(1)-208(n), for example, may be configured to operate as virtual instances on the same physical machine. In other words, one or more of the CRMA device 202, the server devices 204(1)-204(n), or the client devices 208(1)-208(n) may operate on the same physical device rather than as separate devices communicating through communication network(s) 210. Additionally, there may be more or fewer CRMA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

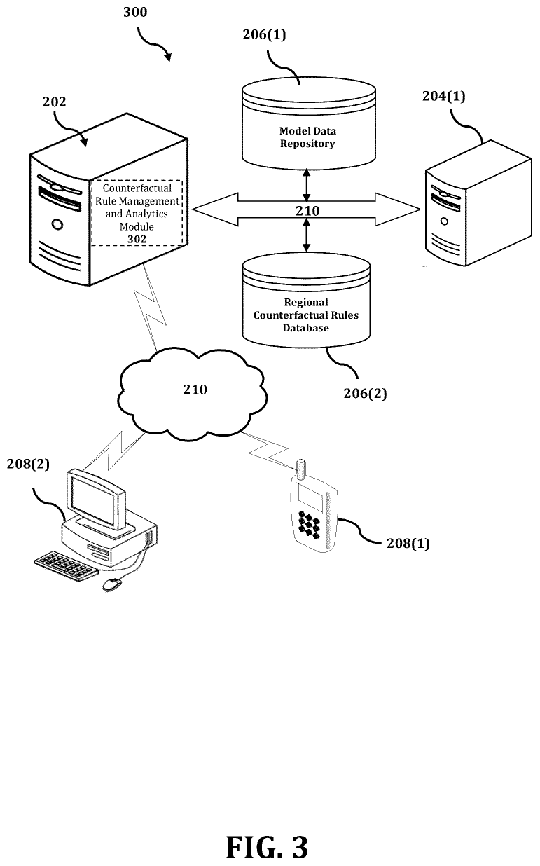

The CRMA device 202 is described and shown in FIG. 3 as including a counterfactual rule management and analytics module 302, although it may include other rules, policies, modules, databases, or applications, for example. As will be described below, the counterfactual rule management and analytics module 302 is configured to implement a method for providing a model-agnostic process for counterfactual explanation that utilizes identified regions of optimality to summarize recourse options as generalized rules.

An exemplary process 300 for implementing a mechanism for providing a model-agnostic process for counterfactual explanation that utilizes identified regions of optimality to summarize recourse options as generalized rules by utilizing the network environment of FIG. 2 is shown as being executed in FIG. 3. Specifically, a first client device 208(1) and a second client device 208(2) are illustrated as being in communication with CRMA device 202. In this regard, the first client device 208(1) and the second client device 208(2) may be “clients” of the CRMA device 202 and are described herein as such. Nevertheless, it is to be known and understood that the first client device 208(1) and/or the second client device 208(2) need not necessarily be “clients” of the CRMA device 202, or any entity described in association therewith herein. Any additional or alternative relationship may exist between either or both of the first client device 208(1) and the second client device 208(2) and the CRMA device 202, or no relationship may exist.

Further, CRMA device 202 is illustrated as being able to access a model data repository 206(1) and a regional counterfactual rules database 206(2). The counterfactual rule management and analytics module 302 may be configured to access these databases for implementing a method for providing a model-agnostic process for counterfactual explanation that utilizes identified regions of optimality to summarize recourse options as generalized rules.

The first client device 208(1) may be, for example, a smart phone. Of course, the first client device 208(1) may be any additional device described herein. The second client device 208(2) may be, for example, a PC. Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CRMA device 202 via broadband or cellular communication. Of course, these embodiments are merely exemplary and are not limiting or exhaustive.

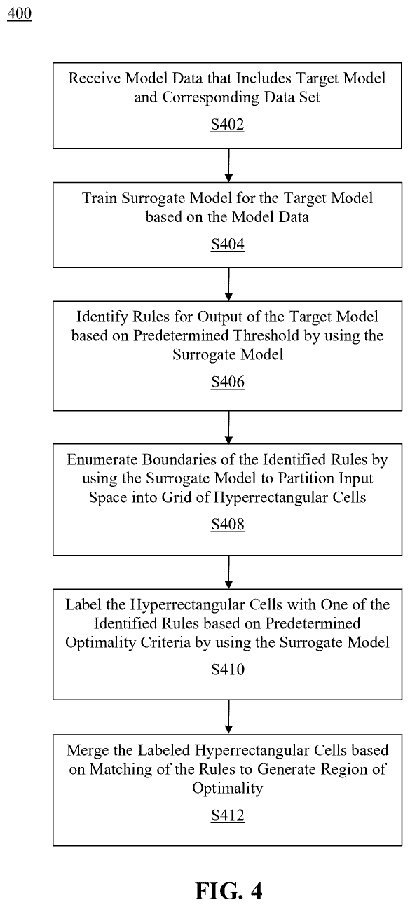

Upon being started, the counterfactual rule management and analytics module 302 executes a process for providing a model-agnostic process for counterfactual explanation that utilizes identified regions of optimality to summarize recourse options as generalized rules. An exemplary process for providing a model-agnostic process for counterfactual explanation that utilizes identified regions of optimality to summarize recourse options as generalized rules is generally indicated at flowchart 400 in FIG. 4.

In the process 400 of FIG. 4, at step S402, model data may be received via a plurality of inputs. The model data may include information that relates to a target model and a corresponding data set. The corresponding data set may include data labelled by the target model. In an exemplary embodiment, the target model may include at least one from among a deep learning model, a neural network model, a machine learning model, a mathematical model, and a process model. The target model may also include stochastic models such as, for example, Markov models that are usable to model randomly changing systems. In stochastic models, the future states of a system may be assumed to depend only on the current state of the system.

In another exemplary embodiment, machine learning and pattern recognition may include supervised learning algorithms such as, for example, k-medoids analysis, regression analysis, decision tree analysis, random forest analysis, k-nearest neighbors analysis, support vector machine (SVM) analysis, logistic regression analysis, etc. In another exemplary embodiment, machine learning analytical techniques may include unsupervised learning algorithms such as, for example, Apriori algorithm analysis, K-means clustering analysis, etc. In another exemplary embodiment, machine learning analytical techniques may include reinforcement learning algorithms such as, for example, Markov Decision Process analysis, etc.

In another exemplary embodiment, the model may be based on a machine learning algorithm. The machine learning algorithm may include at least one from among a process and a set of rules to be followed by a computer in calculations and other problem-solving operations such as, for example, a linear regression algorithm, a logistic regression algorithm, a decision tree algorithm, and/or a Naive Bayes algorithm.

In another exemplary embodiment, the machine learning process may include a neural network that relates to at least one from among an artificial neural network and a simulated neural network. The neural network may correspond to a technique in artificial intelligence that teaches computers to process data by using interconnected processing nodes and/or artificial neurons. The neural network may relate to a type of machine learning such as, for example, deep learning that uses interconnected nodes and/or artificial neurons in a layered structure to transform inputs for predictive analytics.

In another exemplary embodiment, the model may include training models such as, for example, a machine learning model which is generated to be further trained on additional data. Once the training model has been sufficiently trained, the training model may be deployed onto various connected systems to be utilized. In another exemplary embodiment, the training model may be sufficiently trained when model assessment methods such as, for example, a holdout method, a K-fold-cross-validation method, and a bootstrap method determine that at least one of the training model's least squares error rate, true positive rate, true negative rate, false positive rate, and false negative rates are within predetermined ranges.

In another exemplary embodiment, the training model may be operable, i.e., actively utilized by an organization, while continuing to be trained using new data. In another exemplary embodiment, the models may be generated using at least one from among an artificial neural network technique, a decision tree technique, a support vector machines technique, a Bayesian network technique, and a genetic algorithms technique.

At step S404, a surrogate model may be trained for the target model based on the model data. In an exemplary embodiment, the surrogate model may correspond to a tree-based machine learning model that includes a plurality of nodes. The plurality of nodes may include end nodes such as, for example, leaves that represents a hyperrectangular rule. The leaves may be merged to create larger rules.

Consistent with present disclosures, the surrogate model may include at least one from among a deep learning model, a neural network model, a machine learning model, a mathematical model, and a process model. The surrogate model may also include stochastic models such as, for example, Markov models that are usable to model randomly changing systems. In stochastic models, the future states of a system may be assumed to depend only on the current state of the system.

At step S406, rules may be identified for an output of the target model based on a predetermined threshold. Each of the rules may include a counterfactual rule. The rules may be identified by using the surrogate model. In an exemplary embodiment, given a model f: [symbol] → [symbol] and an input x_0∈ [symbol] , a counterfactual rule R⊆ [symbol] is a subset of the input space in which the model gives a different output y≠f(x_0) with high probability under data distribution D:

$${ℙ}_{x ∼ D} [ f ( x ) \neq f ( {x}_{0} ) \vert x ∈ R ] < ( 1 - τ ) .$$

Consistent with present disclosures, rules may be considered in the form of axis-aligned hyperrectangles, i.e., as conjunctions of intervals along input features.

In another exemplary embodiment, the identifying of the rules may include determining end nodes based on the model data. The end nodes may be determined by using the surrogate model. The end nodes may correspond to a mapping of the counterfactual rule in the input space. Then, each of the end nodes may be merged based on a matching of shared characteristics. The end nodes may be merged by using the surrogate model.

In another exemplary embodiment, the predetermined threshold may include a threshold value that defines a minimum probability of a different model output for the output of the target model. The threshold value may include a percentage value such as, for example, a ninety percent value. That is, for a given model output, rules may be found for which the probability of a different model output is at least a predetermined threshold value such as, for example, τ=0.9 or 90%.

At step S408, boundaries for each of the identified rules may be enumerated to partition an input space into a grid with cells. The boundaries may be enumerated for each of the identified rules by using the surrogate model. Each of the cells in the grid may include hyperrectangular cells.

At step S410, each of the cells may be labeled with one of the identified rules based on predetermined optimality criteria. The cells may be labeled with the identified rules by using the surrogate model. In an exemplary embodiment, having mined a set of counterfactual rules, a procedure may be necessary for deciding which is the optimal rule to return as a counterfactual explanation for x_0. Additionally, in the event of tie between two or more rules on the sparsity criterion, a secondary factor may also be necessary.

In another exemplary embodiment, the predetermined optimality criteria may include a sparsity criterion that requires a minimal change in a feature value of the target model to alter a predictive outcome. For example, counterfactual rules may be identified that require the minimum number of features to be changed starting at x_0:

$$numChanges ( {x}_{0} , R ) = {\sum }_{d ∈ features} 𝕀 [ {x}_{0}^{d} \leq lower ( R , d ) ⋁ upper ( R , d ) < {x}_{0}^{d} ] ,$$

where lower (R, d) and upper (R,d) are the lower and upper bounds of rule R along feature d.

In another exemplary embodiment, the predetermined optimality criteria may include a feasibility criterion that requires selection of one of the identified rules according to a proportion of data points within the rules. For example, the feasibility criterion may prefer a higher proportion of data points and require selection of the rule with a higher proportion of data points within said rule. The feasibility criterion may be required when more than one of the identified rules satisfy the sparsity criterion. For example, given a data distribution D, let the feasibility of a rule be the proportion of data points that fall within it.

$$feasibility ( R ) = {ℙ}_{x ∼ D} [ x ∈ R ] .$$

Sparsity ties may be broken by choosing the rule with the highest feasibility. Intuitively, when a rule contains more data, the rule is likely to be more realistic as a target for recourse. This intuition aligns with prior methods that prioritize counterfactuals in highly populated regions of the input space.

At step S412, each of the labeled cells may be merged based on a matching of the rules to generate regions of optimality. The labeled cells may be merged by using the surrogate model. For example, given a set of counterfactual rules [symbol] , consider the region of input space for which each rule is optimal:

$$region ( R ) = \{ {x}_{0} ∈ 𝒳 : R is the optimal rule for x \} , for each R ∈ ℛ .$$

For hyperrectangular rules and previously disclosed two-part definition of optimality based on sparsity and feasibility, these regions of optimality are also bounded by (one or more) hyperrectangles. Enumerating these regions allows for movement beyond the local specification of counterfactuals for individual points to a global summary of the counterfactual structure of f. In particular, since both the rules and regions of optimality are hyperrectangles, the rules and regions may be assembled into a global textual summary of all counterfactuals using if-else statements.

In another exemplary embodiment, regional rules that summarize a plurality of recourse options may be generated based on the generated regions of optimality. The regional rules may be generated by using the surrogate model. In another exemplary embodiment, the regional rules may be assembled into a global textual summary of the plurality of recourse options. The global textual summary may include conditional statements such as, for example, if-else statements that summarizes recourse options for both individuals and groups. The global textual summary may summarize recourse options in the form of generalized rules rather than isolated examples. For example, the global textual summary may summarize recourse options for a particular age group instead of for each individual customer within the age group.

In another exemplary embodiment, requests may be received to generate a local counterfactual explanation for a single instance of the output. Consistent with present disclosures, the generated rules and regions of optimality may only need to be computed once and can be reused to generate the local counterfactual explanation for any single instance by simple lookup. As such, identification of local counterfactual explanations may be accomplished extremely quickly.

Thus, once the requests are received, a search of each of the generated regions of optimality may be conducted for the single instance of the output. The generated region of optimality that corresponds to the single instance of the output may include a precalculated and optimized counterfactual rule. Then, a report may be generated in response to each of the requests. The report may include the precalculated and optimized counterfactual rule for the single instance of the output.

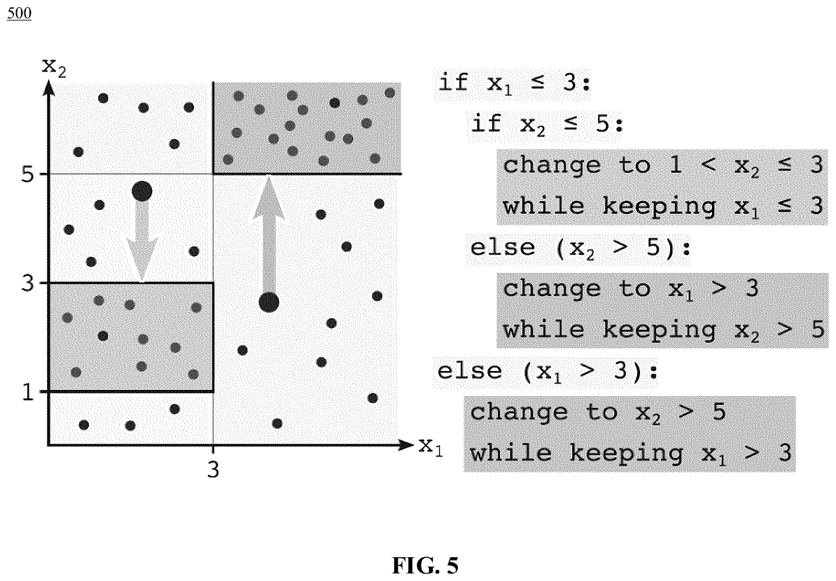

FIG. 5 is a graphical representation 500 of an exemplary process for implementing a method for providing a model-agnostic process for counterfactual explanation that utilizes identified regions of optimality to summarize recourse options as generalized rules. In FIG. 5, a graphical display of the regions of optimality and corresponding conditional statements are provided as exemplary embodiments.

As illustrated in FIG. 5, recourse options are summarized for both individual and groups in the form of regional rules. Since both the rules and regions of optimality are hyperrectangles, the rules may be extracted from the regions and assembled into a global textual summary of all counterfactuals by using conditional statements such as, for example, if-else statements. The global textual summary may provide both a global analysis of model behavior and diverse recourse options for users in various regions.

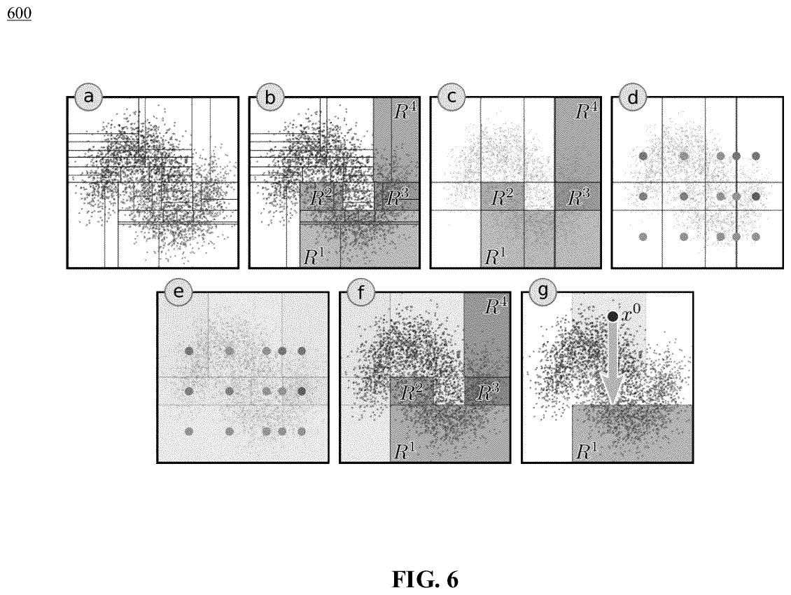

FIG. 6 is a graphical sequence 600 of an exemplary process for implementing a method for providing a model-agnostic process for counterfactual explanation that utilizes identified regions of optimality to summarize recourse options as generalized rules. In FIG. 6, an efficient, model-agnostic algorithm is provided for local and global counterfactual explanations. The algorithm may leverage tree-based surrogate models to mine counterfactual rules and identify regions of optimality for said counterfactual rules.

As illustrated in FIG. 6, at step (a), a tree-based surrogate model may be learned from data labelled by the target model. Each leaf of the surrogate model may correspond to a hyperrectangular rule. Leaves from the tree-based surrogate model may be merged to create larger rules. At step (b), for a given model output, rules may be found for which the probability of a different model output is at least a predetermined threshold value such as, for example, τ=0.9 or 90%. Consistent with present disclosures, the rules may be merged to create larger rules when possible.

At step (c), all unique boundaries may be enumerated in the identified rules and used to partition the input space into a grid of hyperrectangular cells. At step (d), each grid cell may be labelled with a unique rule, which is optimal for all points in the cell. The optimizing of the rules may be accomplished by using the sparsity-based and feasibility-based optimality definition. At step (e), adjacent grid cells with the same rule label may be merged to create a smaller set of regions. In practice, the merging of adjacent grid cells may be accomplished by growing additional and subsequent tree models.

At step (f), the sets of rules and regions together globally characterizes the counterfactual outputs of the target model from a first set of data points to a second set of data points. Steps (b)-(e) may be repeated for counterfactual outputs from the second set of data points to the first set of data points. Finally, at step (g), local explanations may be determined by using the calculated rules and regions. The rules and regions may only need to be computed once and reused to generate a local explanation for any single instance by simple lookup, which makes local explanation identification extremely fast.

Accordingly, with this technology, an optimized process for providing a model-agnostic process for counterfactual explanation that utilizes identified regions of optimality to summarize recourse options as generalized rules is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for computing regional counterfactual rules to summarize recourse options, the method being implemented by at least one processor, the method comprising:
receiving, by the at least one processor, model data via at least one input, the model data including information that relates to a target model and a corresponding data set;
training, by the at least one processor, a surrogate model for the target model based on the model data;
identifying, by the at least one processor using the surrogate model, at least one rule for an output of the target model based on a predetermined threshold, each of the at least one rule including a counterfactual rule;
enumerating, by the at least one processor using the surrogate model, at least one boundary for each of the identified at least one rule to partition an input space into a grid with at least one cell, each of the at least one cell including a hyperrectangular cell;
labeling, by the at least one processor using the surrogate model, each of the at least one cell with one of the identified at least one rule based on predetermined optimality criteria; and
merging, by the at least one processor using the surrogate model, each of the labeled at least one cell based on a matching of the at least one rule to generate at least one region of optimality.

2. The method of claim 1, further comprising:
generating, by the at least one processor using the surrogate model, at least one regional rule that summarizes a plurality of recourse options based on the generated at least one region of optimality,
wherein the at least one regional rule is assembled into a global textual summary of the plurality of recourse options; and
wherein the global textual summary includes at least one conditional statement.

3. The method of claim 1, wherein each of the at least one surrogate model corresponds to a tree-based machine learning model that includes a plurality of nodes, the plurality of nodes including at least one end node that represents a hyperrectangular rule.

4. The method of claim 1, wherein the identifying of the at least one rule further comprises:
determining, by the at least one processor using the surrogate model, at least one end node based on the model data,
wherein each of the at least one end node corresponds to a mapping of the counterfactual rule in the input space; and
merging, by the at least one processor using the surrogate model, each the at least one end node based on a matching of at least one characteristic.

5. The method of claim 1, wherein the predetermined threshold includes a threshold value that defines a minimum probability of a different model output for the output of the target model, the threshold value including a percentage value.

6. The method of claim 1, wherein the predetermined optimality criteria include a sparsity criterion that requires a minimal change in a feature value of the target model to alter a predictive outcome.

7. The method of claim 6, wherein the predetermined optimality criteria include a feasibility criterion that requires selection of one of the identified at least one rule according to a proportion of data points within the identified at least one rule when more than one of the identified at least one rule satisfy the sparsity criterion.

8. The method of claim 1, further comprising:
receiving, by the at least one processor, at least one request to generate a local counterfactual explanation for a single instance of the output;
searching, by the at least one processor, each of the generated at least one region of optimality for the single instance of the output,
wherein the generated at least one region of optimality that corresponds to the single instance of the output includes a precalculated and optimized counterfactual rule; and
generating, by the at least one processor, a report in response to each of the at least one request, the report including the precalculated and optimized counterfactual rule for the single instance of the output.

9. The method of claim 1, wherein the target model includes at least one from among a deep learning model, a neural network model, a machine learning model, a mathematical model, and a process model.

10. A computing device configured to implement an execution of a method for computing regional counterfactual rules to summarize recourse options, the computing device comprising:
a processor;
a memory; and
a communication interface coupled to each of the processor and the memory,
wherein the processor is configured to:
receive model data via at least one input, the model data including information that relates to a target model and a corresponding data set;
train a surrogate model for the target model based on the model data;
identify, by using the surrogate model, at least one rule for an output of the target model based on a predetermined threshold, each of the at least one rule including a counterfactual rule;
enumerate, by using the surrogate model, at least one boundary for each of the identified at least one rule to partition an input space into a grid with at least one cell, each of the at least one cell including a hyperrectangular cell;
label, by using the surrogate model, each of the at least one cell with one of the identified at least one rule based on predetermined optimality criteria; and
merge, by using the surrogate model, each of the labeled at least one cell based on a matching of the at least one rule to generate at least one region of optimality.

11. The computing device of claim 10, wherein the processor is further configured to:
generate, by using the surrogate model, at least one regional rule that summarizes a plurality of recourse options based on the generated at least one region of optimality,
wherein the at least one regional rule is assembled into a global textual summary of the plurality of recourse options; and
wherein the global textual summary includes at least one conditional statement.

12. The computing device of claim 10, wherein each of the at least one surrogate model corresponds to a tree-based machine learning model that includes a plurality of nodes, the plurality of nodes including at least one end node that represents a hyperrectangular rule.

13. The computing device of claim 10, wherein, to identify the at least one rule, the processor is further configured to:
determine, by using the surrogate model, at least one end node based on the model data,
wherein each of the at least one end node corresponds to a mapping of the counterfactual rule in the input space; and
merge, by using the surrogate model, each the at least one end node based on a matching of at least one characteristic.

14. The computing device of claim 10, wherein the predetermined threshold includes a threshold value that defines a minimum probability of a different model output for the output of the target model, the threshold value including a percentage value.

15. The computing device of claim 10, wherein the predetermined optimality criteria include a sparsity criterion that requires a minimal change in a feature value of the target model to alter a predictive outcome.

16. The computing device of claim 15, wherein the predetermined optimality criteria include a feasibility criterion that requires selection of one of the identified at least one rule according to a proportion of data points within the identified at least one rule when more than one of the identified at least one rule satisfy the sparsity criterion.

17. The computing device of claim 10, wherein the processor is further configured to:
receive at least one request to generate a local counterfactual explanation for a single instance of the output;
search each of the generated at least one region of optimality for the single instance of the output,
wherein the generated at least one region of optimality that corresponds to the single instance of the output includes a precalculated and optimized counterfactual rule; and
generate a report in response to each of the at least one request, the report including the precalculated and optimized counterfactual rule for the single instance of the output.

18. The computing device of claim 10, wherein the target model includes at least one from among a deep learning model, a neural network model, a machine learning model, a mathematical model, and a process model.

19. A non-transitory computer readable storage medium storing instructions for computing regional counterfactual rules to summarize recourse options, the storage medium comprising executable code which, when executed by a processor, causes the processor to:
receive model data via at least one input, the model data including information that relates to a target model and a corresponding data set;
train a surrogate model for the target model based on the model data;
identify, by using the surrogate model, at least one rule for an output of the target model based on a predetermined threshold, each of the at least one rule including a counterfactual rule;
enumerate, by using the surrogate model, at least one boundary for each of the identified at least one rule to partition an input space into a grid with at least one cell, each of the at least one cell including a hyperrectangular cell;
label, by using the surrogate model, each of the at least one cell with one of the identified at least one rule based on predetermined optimality criteria; and
merge, by using the surrogate model, each of the labeled at least one cell based on a matching of the at least one rule to generate at least one region of optimality.

20. The storage medium of claim 19, wherein, when executed by the processor, the executable code further causes the processor to:
generate, by using the surrogate model, at least one regional rule that summarizes a plurality of recourse options based on the generated at least one region of optimality,
wherein the at least one regional rule is assembled into a global textual summary of the plurality of recourse options; and
wherein the global textual summary includes at least one conditional statement.
